(19) United States
(12) Patent Application Publication
(10) Pub. No.: US 2016/0269735 A1
(43) Pub. Date: Sep. 15, 2016

(54) IMAGE ENCODING METHOD AND APPARATUS, AND IMAGE DECODING METHOD AND APPARATUS

(71) Applicant: Electronics and Telecommunications Research Institute, Daejeon (KR)

(72) Inventors: Younhee KIM, Daejeon (KR); Soon Heung JUNG, Daejeon (KR); Jin Wuk SEOK, Daejeon (KR); Hui Yong KIM, Daejeon (KR); Jin Soo CHOI, Daejeon (KR)

(21) Appl. No.: 15/007,551

(22) Filed: Jan. 27, 2016

(30) Foreign Application Priority Data
Mar. 9, 2015 (KR) 10-2015-0032696

(51) Int. Cl. H04N 19/44; H04N 19/436; H04N 19/177; H04N 19/17

(52) U.S. Cl. CPC H04N 19/44; H04N 19/17; H04N 19/436; H04N 19/177

(57) ABSTRACT

An image encoding method and apparatus and an image decoding method and apparatus are provided. The image encoding method and image decoding method may enhance performance of the image encoding apparatus and performance of the image decoding apparatus by adaptively applying a tile-based parallel encoding scheme, a frame-based parallel encoding scheme, and an instantaneous decoding refresh (IDR) period-based parallel encoding scheme.

### CROSS-REFERENCE TO RELATED APPLICATION

This application claims the benefit of Korean Patent Application No. 10-2015-0032696, filed on Mar. 9, 2015, in the Korean Intellectual Property Office, the disclosure of which is incorporated herein by reference.

### BACKGROUND

1. Field of the Invention

Embodiments relate to an image encoding method and apparatus and an image decoding method and apparatus, and more particularly, to an image encoding method and apparatus based on parallel processing and an image decoding method and apparatus based on parallel processing.

2. Description of the Related Art

Recently, broadcasting systems supporting a high definition (HD) resolution have been expanded both globally and locally. Accordingly, a large number of users are increasingly interested in HD televisions (TVs) capable of playing back high-quality image with a higher resolution. Also, recently, due to an increase in an interest in an ultra HDTV (UHDTV) supporting a resolution four times than that of an HDTV, along with an increase in an interest in the HDTV, a technology of compressing a high-quality image with a higher resolution has been required.

In particular, users have demanded a method of compressing a high-resolution image with a high efficiency, in addition to a large-sized image display screen. Accordingly, a next generation codec standardization called High Efficiency Video Coding (HEVC) having a compression capability enhanced by 50% in comparison to an Advanced Video Coding (AVC)/H.264 codec, was completed in 2013 by a Joint Collaborative Team On Video Coding (JCT-VC).

The compression capability of the HEVC has been enhanced, however, a complexity of an image encoder has been greatly increased. Also, to encode, using the HEVC, a high-resolution image, for example, a 4K resolution image, or a bulk image with an increased frame rate and to utilize the above images in broadcasting services, a high-speed HEVC image encoding apparatus is necessarily used. To implement the above high-speed HEVC image encoding apparatus, effective parallel processing is important. Because different performances and different operating hardware platforms are required for each application field in which an image encoding apparatus is to be used, an encoding method to adaptively perform parallel processing is demanded.

### SUMMARY

Embodiments provide an image encoding method and apparatus, and an image decoding method and apparatus. To solve the above problems, embodiments provide an apparatus and method for encoding and decoding a high-resolution image at a high speed by adaptively applying a parallel processing scheme of an image encoding apparatus and an image decoding apparatus.

According to an aspect, there is provided an image encoding method performed by an image encoding apparatus, the image encoding method including verifying a number of available processors, dividing a frame into a plurality of tiles based on the verified number of available processors, and encoding the plurality of tiles in parallel.

According to another aspect, there is provided an image encoding method performed by an image encoding apparatus, the image encoding method including identifying a plurality of frames included in a group of picture (GOP), determining a GOP level based on a reference relationship among the plurality of frames, processing frames corresponding to the same GOP level based on the determined GOP level so that the frames corresponding to the same GOP level do not reference each other, and encoding, in parallel, the processed frames for each GOP level.

According to another aspect, there is provided an image encoding method performed by an image encoding apparatus, the image encoding method including identifying a plurality of frames included in a GOP, processing frames corresponding to the same GOP level among GOP levels of the identified frames so that the frames corresponding to the same GOP level do not reference each other, dividing each of the processed frames into a plurality of tiles based on a number of available processors, and encoding, in parallel, the processed frames for each of the GOP levels and for each of the plurality of tiles.

According to another aspect, there is provided an image encoding method performed by an image encoding apparatus, the image encoding method including identifying a plurality of frames of an image, and encoding the image by adaptively combining at least one of a tile-based parallel encoding scheme, a frame-based parallel encoding scheme, and an instantaneous decoding refresh (IDR) period-based parallel encoding scheme.

The encoding of the image may include dividing each of the plurality of frames into a plurality of tiles based on a number of available processors and encoding the plurality of tiles in parallel.

The encoding of the image may include processing frames corresponding to the same GOP level so that the frames corresponding to the same GOP level do not reference each other, and encoding the processed frames in parallel.

The encoding of the image may include encoding the plurality of frames in parallel every IDR period.

The IDR period may correspond to frames between an I-frame and the next I-frame.

According to another aspect, there is provided an image decoding method performed by an image decoding apparatus, the image decoding method including receiving an image, and decoding the received image, wherein the image is encoded by dividing a frame of the image into a plurality of tiles based on a number of available processors and by encoding the plurality of tiles in parallel.

According to another aspect, there is provided an image decoding method performed by an image decoding apparatus, the image decoding method including receiving an image, and decoding the received image, wherein the image is encoded by processing frames corresponding to the same GOP level so that the frames corresponding to the same GOP level do not reference each other and by encoding the processed frames in parallel.

According to another aspect, there is provided an image decoding method performed by an image decoding apparatus, the image decoding method including receiving an image, and decoding the received image, wherein the image is encoded by processing frames corresponding to the same GOP level so that the frames corresponding to the same GOP level do not reference each other, by dividing each of the processed frames into a plurality of tiles based on a number of available processors, and by encoding, in parallel, the processed frames for each GOP level and for each of the plurality of tiles.

According to another aspect, there is provided an image decoding method performed by an image decoding apparatus, the image decoding method including receiving an image, and decoding the received image, wherein the image is encoded by encoding a plurality of frames of the image by combining at least one of a tile-based parallel encoding scheme, a frame-based parallel encoding scheme, and an IDR period-based parallel encoding scheme.

According to another aspect, there is provided an image encoding apparatus including a number-of-processors verifier configured to verify a number of available processors, a frame divider configured to divide a frame into a plurality of tiles based on the verified number of available processors, and an encoder configured to encode the plurality of tiles in parallel.

According to another aspect, there is provided an image encoding apparatus including a frame identifier configured to identify a plurality of frames included in a GOP, a GOP level determiner configured to determine a GOP level based on a reference relationship among the plurality of frames, a controller configured to process frames corresponding to the same GOP level based on the determined GOP level so that the frames corresponding to the same GOP level do not reference each other, and an encoder configured to encode, in parallel, the processed frames for each GOP level.

According to another aspect, there is provided an image encoding apparatus including a frame identifier configured to identify a plurality of frames included in a GOP, a controller configured to process frames corresponding to the same GOP level among GOP levels of the identified frames so that the frames corresponding to the same GOP level do not reference each other, a frame divider configured to divide each of the processed frames into a plurality of tiles, based on a number of available processors, and an encoder configured to encode, in parallel, the processed frames for each of the GOP levels and for each of the plurality of tiles.

According to another aspect, there is provided an image encoding apparatus including a frame identifier configured to identify a plurality of frames of an image, and an encoder configured to encode the image by adaptively combining at least one of a tile-based parallel encoding scheme, a frame-based parallel encoding scheme, and an IDR period-based parallel encoding scheme

According to another aspect, there is provided an image decoding apparatus including an image receiver configured to receive an image, and a decoder configured to decode the received image, wherein the image is encoded by dividing a frame of the image into a plurality of tiles based on a number of available processors and by encoding the plurality of tiles in parallel.

According to another aspect, there is provided an image decoding apparatus including an image receiver configured to receive an image, and a decoder configured to decode the received image, wherein the image is encoded by processing frames corresponding to the same GOP level so that the frames corresponding to the same GOP level do not reference each other and by encoding the processed frames in parallel.

According to another aspect, there is provided an image decoding apparatus including an image receiver configured to receive an image, and a decoder configured to decode the received image, wherein the image is encoded by processing frames corresponding to the same GOP level so that the frames corresponding to the same GOP level do not reference each other, by dividing each of the processed frames into a plurality of tiles based on a number of available processors, and by encoding, in parallel, the processed frames for each GOP level and for each of the plurality of tiles.

According to another aspect, there is provided an image decoding apparatus including an image receiver configured to receive an image, and a decoder configured to decode the received image, wherein the image is encoded by encoding a plurality of frames of the image by combining at least one of a tile-based parallel encoding scheme, a frame-based parallel encoding scheme, and an IDR period-based parallel encoding scheme.

### Effect

According to embodiments, an image encoding apparatus and an image decoding apparatus may encode and decode a high-resolution image at a high speed by adaptively applying various parallel processing schemes.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an image encoding apparatus according to an embodiment;

FIG. 2 illustrates an image decoding apparatus according to an embodiment;

FIG. 3 illustrates a method of determining a level of each of frames included in a group of picture (GOP) according to an embodiment;

FIG. 4 illustrates an example of a tile-based parallel encoding scheme according to an embodiment;

FIG. 5 illustrates an example of a frame-based parallel encoding scheme according to an embodiment;

FIG. 6 illustrates an example of a tile-based parallel encoding scheme and an example of a frame-based parallel encoding scheme according to an embodiment;

FIG. 7 illustrates an example of a tile-based parallel encoding scheme, an example of a frame-based parallel encoding scheme, and an example of an instantaneous decoding refresh (IDR) period-based parallel encoding scheme according to an embodiment; and

FIGS. 8A and 8B illustrate a number of threads occurring over time when parallel encoding is performed by combining various parallel encoding schemes according to an embodiment.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

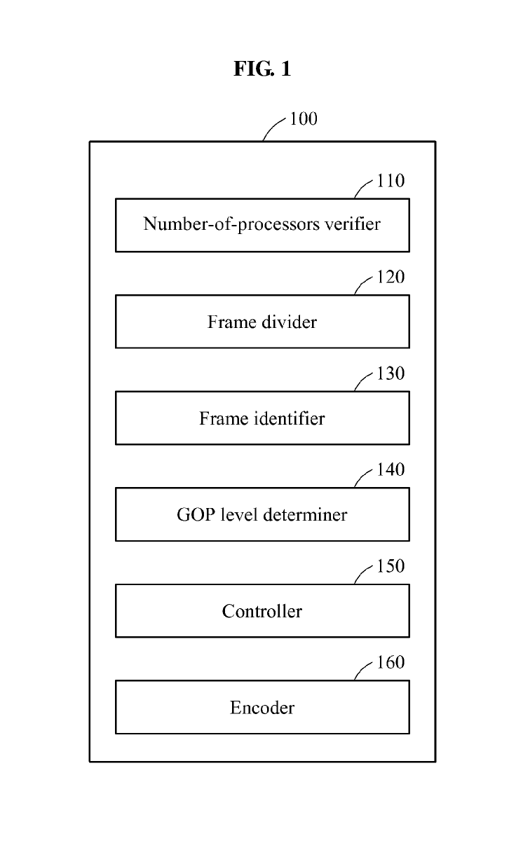

FIG. 1 illustrates an image encoding apparatus 100 according to an embodiment.

Referring to FIG. 1, the image encoding apparatus 100 may include a number-of-processors verifier 110, a frame divider 120, a frame identifier 130, a group of picture (GOP) level determiner 140, a controller 150 and an encoder 160. The number-of-processors verifier 110 may verify a number of processors used to perform encoding in the image encoding apparatus 100. A processor may include, for example, an existing central processing unit (CPU) and a graphics processing unit (GPU) that is a key device of a graphics card as a high-performance processing unit for graphics processing. In the related art, a graphics card attached to a personal computer (PC) functions as an adapter to convert an operation result of a CPU to picture or letter signals and to display the picture or letter signals on a monitor screen. However, recently, GPUs are being used in various fields, for example, image encoding or decryption, in addition to simple graphic works. Also, a multi-GPU environment may be implemented by simultaneously mounting at least two GPUs in a single substrate, to increase performance Thus, the number-of-processors verifier 110 may verify a number of CPUs and a number of GPUs available for encoding of the image encoding apparatus 100.

The frame divider 120 may divide each of frames of an image into tiles during encoding of each of the frames. The tiles may refer to a minimum unit acquired by dividing a frame. When the frame divider 120 divides each of frames of an image into tiles, the following two cases may occur. In a first case, the image encoding apparatus 100 may encode the tiles in parallel. In this case, the frame divider 120 may verify a maximum frame division number based on the number of processors acquired by the number-of-processors verifier 110, and may divide each of the frames into tiles. In embodiments, the maximum frame division number may refer to a maximum number of tiles into which a frame is divided and that is to be processed in parallel. In a second case, the image encoding apparatus 100 may simultaneously perform a parallel encoding scheme based on the tiles and a parallel encoding scheme based on the frames. In this case, the frame divider 120 may verify the maximum frame division number based on a number of frames capable of being processed in parallel based on a GOP level and the number of processors acquired by the number-of-processors verifier 110, and may divide each of the frames into tiles.

The frame identifier 130 may identify each of frames of an image based on a reference relationship during encoding of each of the frames. A GOP may include three types of frames, for example, an intra-coded frame (I-frame), a predictive-coded frame (P-frame) and a bidirectionally predictive-coded frame (B-frame). The I-frame may be associated with intra-frame encoding, and may refer to a frame that is compressed without reference to other frames and that is capable of being independently restored. The P-frame may be associated with inter-frame forward prediction encoding, and may refer to a frame that is compressed with reference to an I-frame or another P-frame and that is incapable of being independently restored. The B-frame may be used in both inter-frame forward prediction encoding and inter-frame backward prediction encoding. The B-frame may be refer to a frame that is compressed with reference to both a previous I-frame or P-frame and a next I-frame or P-frame and that is incapable of being independently restored.

The GOP level determiner 140 may determine a level of each of frames included in a GOP based on the frames identified by the frame identifier 130. The level of each of the frames in the GOP may be determined based on a number of the frames in the GOP, a reference relationship among the frames in the GOP and a number of frames for each level.

For example, the GOP level determiner 140 may set a higher level to a frame having a larger number of reference frames used to encode the frame among the frames in the GOP. Also, the GOP level determiner 140 may set a lower level to a frame having a smaller number of reference frames used to encode the frame among the frames in the GOP.

The controller 150 may process frames corresponding to the same level based on a GOP level determined by the GOP level determiner 140 so that the frames corresponding to the same level may not reference each other.

The encoder 160 may encode each of frames of an image using one of a tile-based parallel encoding scheme, a frame-based parallel encoding scheme and an instantaneous decoding refresh (IDR) period-based parallel encoding scheme. Also, the encoder 160 may encode the image by adaptively combining at least one of the tile-based parallel encoding scheme, the frame-based parallel encoding scheme and the IDR period-based parallel encoding scheme. In accordance with embodiments, the tile-based parallel encoding scheme, the frame-based parallel encoding scheme, and the IDR period-based parallel encoding scheme may refer to a scheme of encoding tiles in parallel, a scheme of encoding frames in parallel, and a scheme of encoding frames in parallel every IDR period, respectively.

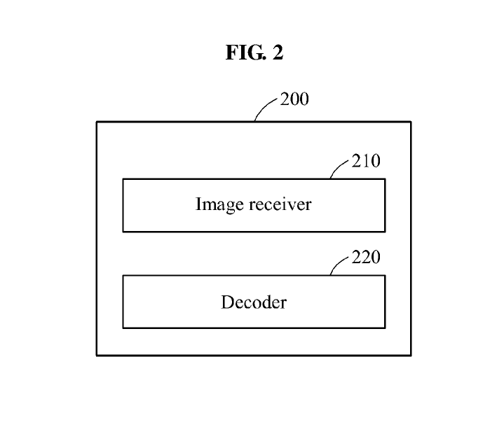

FIG. 2 illustrates an image decoding apparatus 200 according to an embodiment.

Referring to FIG. 2, the image decoding apparatus 200 may include an image receiver 210 and a decoder 220. The image receiver 210 may receive an encoded image. In an example, the encoded image may be obtained by dividing a frame of the image into a plurality of tiles based on a number of available processors and by encoding the plurality of tiles in parallel. In another example, the encoded image may be obtained by processing frames corresponding to the same GOP level so that the frames corresponding to the same level do not reference each other and by encoding the processed frames in parallel. In still another example, the encoded image may be obtained by processing frames corresponding to the same GOP level so that the frames corresponding to the same GOP level do not reference each other, dividing each of the processed frames based on a number of available processors into a plurality of tiles, and by encoding the processed frames in parallel for each GOP level and for each of the plurality of tiles. In yet another example, the encoded image may be obtained by encoding a plurality of frames of the image by adaptively combining at least one of a tile-based parallel encoding scheme, a frame-based parallel encoding scheme, and an IDR period-based parallel encoding scheme.

The decoder 220 may decode each of frames of an image using one of a tile-based parallel decoding scheme, a frame-based parallel decoding scheme, and an IDR period-based parallel decoding scheme. Also, the decoder 220 may decode the image by adaptively combining at least one of the tile-based parallel decoding scheme, the frame-based parallel decoding scheme and the IDR period-based parallel decoding scheme.

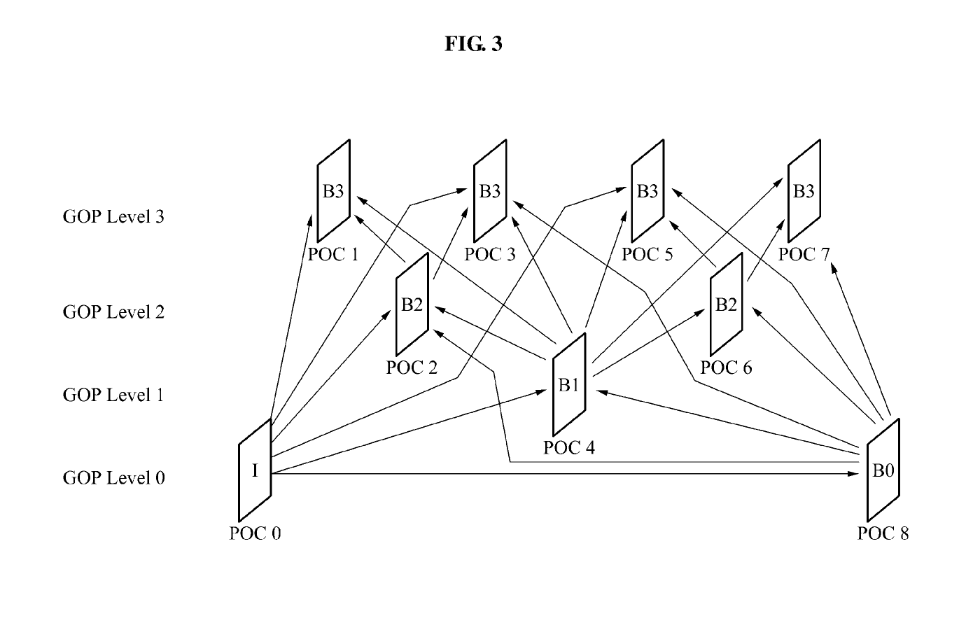

FIG. 3 illustrates a method of determining a level of each of frames included in a GOP according to an embodiment.

The image encoding apparatus 100 of FIG. 1 may determine a level of each of the frames in a GOP. The image encoding apparatus 100 may determine the level of each of the frames in the GOP based on a number of the frames in the GOP, a reference relationship among the frames in the GOP and a number of frames for each of GOP levels.

The number of the frames in the GOP, the reference relationship among the frames in the GOP and the number of frames for each of the GOP levels may be determined by a user. For example, referring to FIG. 3, a GOP including eight frames may be generated, and a reference relationship among the eight frames may be determined. In FIG. 3, a single frame may correspond to GOP level 0, a single frame may correspond to GOP level 1, and two frames may correspond to GOP level 2. Also, four frames may correspond to GOP level 3.

The GOP level determiner 140 in the image encoding apparatus 100 may determine the level of each of the frames in the GOP based on the number of the frames in the GOP, the reference relationship among the frames in the GOP and the number of frames for each of the GOP levels. As shown in FIG. 3, a higher level may be set to a frame having a larger number of reference frames used to encode the frame. Also, a lower level may be set to a frame having a smaller number of reference frames used to encode the frame.

For example, because a frame B0 completely encoded by referencing a frame I has a small number of reference frames, the GOP level determiner 140 may determine a level of the frame B0 as GOP level 0 that is a lowest level. Because a frame B3 completely encoded by referencing frames B0, B1 and B2 has a large number of reference frames, the GOP level determiner 140 may determine a level of the frame B3 as GOP level 3 that is a highest level.

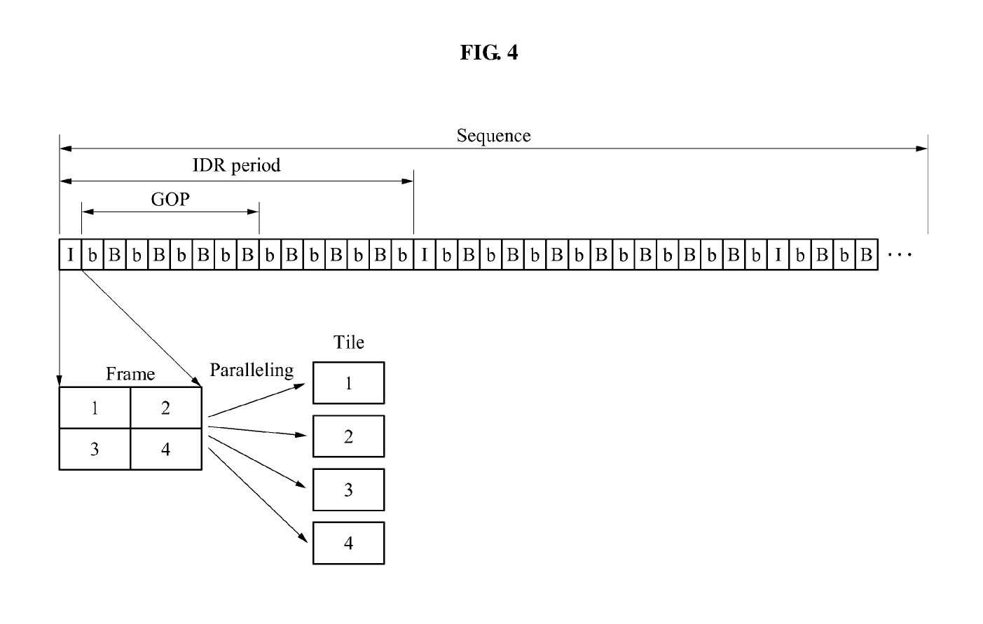

FIG. 4 illustrates an example of a tile-based parallel encoding scheme according to an embodiment.

The image encoding apparatus 100 of FIG. 1 may divide each of frames of an image into tiles and may process the tiles in parallel, to encode the tiles. The image encoding apparatus 100 may verify a number of processors available for encoding. The processors may include, for example, a CPU and a GPU.

The image encoding apparatus 100 may verify a maximum frame division number based on the verified number of the processors, and may divide each of the frames into tiles. The image encoding apparatus 100 may parallel process and encode the tiles, and thus it is possible to increase an efficiency and a speed of image encoding.

In the tile-based parallel encoding scheme, a plurality of tiles may be simultaneously encoded using a processor available for encoding, and accordingly an image encoding speed may increase in comparison to a general scheme of encoding frames. However, according to embodiments, a frame-based parallel encoding scheme may be provided in addition to the tile-based parallel encoding scheme, and thus it is possible to enhance an efficiency of encoding.

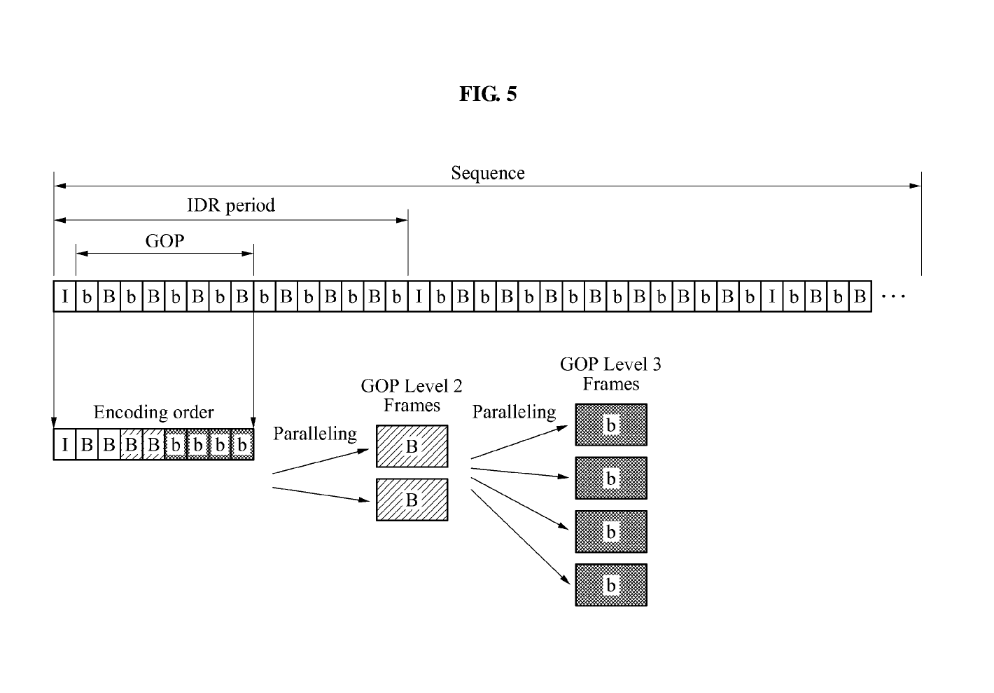

FIG. 5 illustrates an example of a frame-based parallel encoding scheme according to an embodiment.

The image encoding apparatus 100 of FIG. 1 may process frames of an image in parallel and may encode the frames. The image encoding apparatus 100 may determine a level of each of frames included in a GOP, and may encode, in parallel, frames corresponding to the same level. The image encoding apparatus 100 may determine the level of each of the frames in the GOP based on a number of the frames in the GOP, a reference relationship among the frames in the GOP and a number of frames for each GOP level. For example, the GOP level determiner 140 of FIG. 1 may set a higher level to a frame having a larger number of reference frames used to encode the frame among the frames in the GOP. Also, the GOP level determiner 140 may set a lower level to a frame having a smaller number of reference frames used to encode the frame among the frames in the GOP.

The image encoding apparatus 100 may encode the frames in an ascending order of GOP levels determined by the GOP level determiner 140. And frames corresponding to the same level among the GOP levels determined by the GOP level determiner 140 may be processed in parallel and encoded. In this example, the image encoding apparatus 100 may process the frames corresponding to the same level so that the frames corresponding to the same level may not reference each other.

As shown in FIG. 5, the image encoding apparatus 100 may set GOP level 3 that is a highest level to a b-frame having a largest number of reference frames, and may set GOP level 2 to a B-frame having a smaller number of reference frames than the b-frame. The image encoding apparatus 100 may encode the frames in the GOP in the ascending order of GOP levels, may process, in parallel, frames corresponding to the same level, and may encode the processed frames.

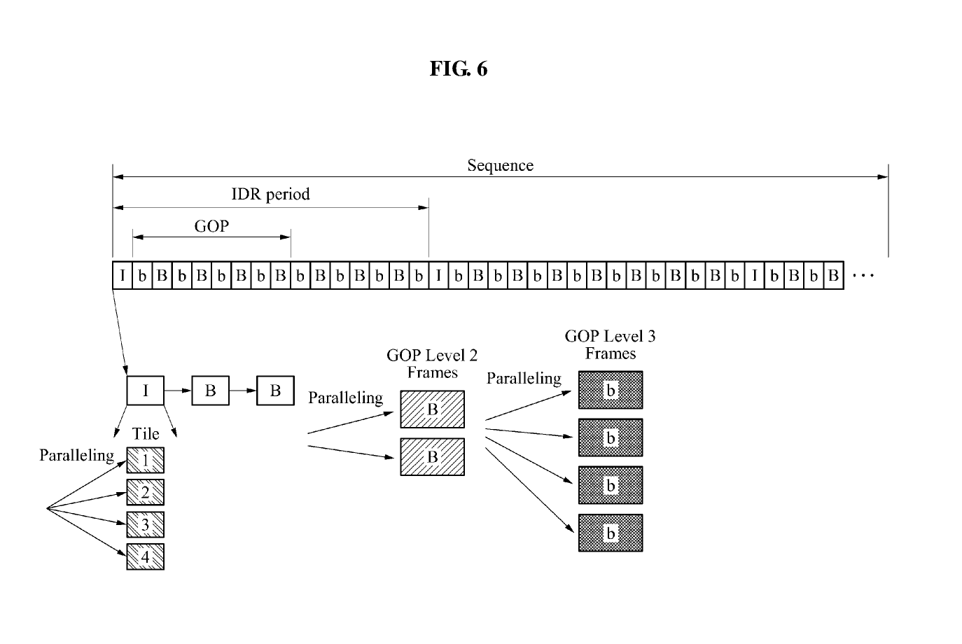

FIG. 6 illustrates an example of a tile-based parallel encoding scheme and an example of a frame-based parallel encoding scheme according to an embodiment.

The image encoding apparatus 100 of FIG. 1 may parallel process and encode frames of an image, and simultaneously may divide each of the frames into tiles and parallel process and encode the tiles. The image encoding apparatus 100 may determine a level of each of frames included in a GOP forming the image, and may encode, in parallel, frames corresponding to the same level. To determine the level of each of the frames in the GOP, the image encoding apparatus 100 may use a reference relationship among the frames. The image encoding apparatus 100 may encode the frames in the GOP in an ascending order of GOP levels determined by the GOP level determiner 140 of FIG. 1, and may encode frames corresponding to the same level using a parallel processing scheme. The image encoding apparatus 100 may process the frames corresponding to the same level so that the frames corresponding to the same level may not reference each other.

Also, the image encoding apparatus 100 may verify a maximum frame division number, based on a number of frames capable of being processed in parallel based on a GOP level and a number of processors acquired by the number-of-processors verifier 110 of FIG. 1, and may divide each of the frames into tiles. The image encoding apparatus 100 may parallel process and encode the frames, and simultaneously may parallel process and encode the tiles obtained based on the verified maximum frame division number.

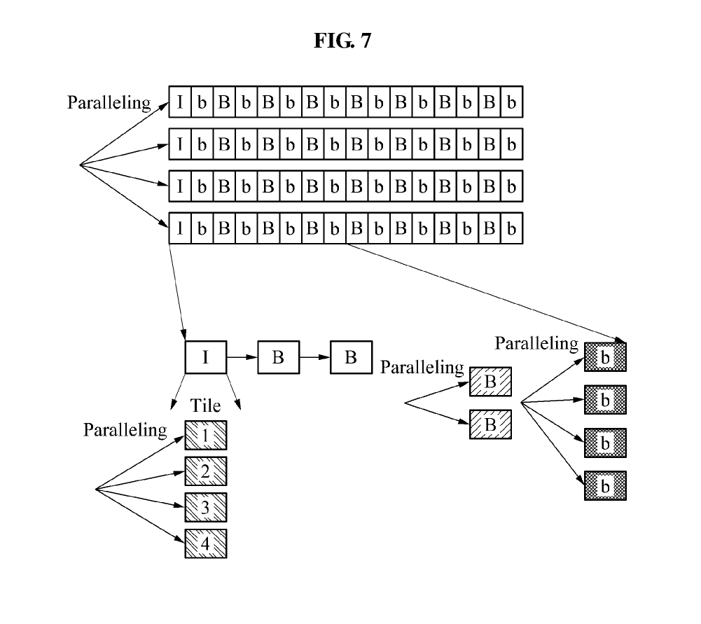

FIG. 7 illustrates an example of a tile-based parallel encoding scheme, an example of a frame-based parallel encoding scheme, and an example of an IDR period-based parallel encoding scheme according to an embodiment.

The image encoding apparatus 100 of FIG. 1 may encode an image both for each tile and for each frame as shown in FIG. 6. Also, the image encoding apparatus 100 may encode the image every IDR period, and thus it is possible to enhance an efficiency of encoding the image. The IDR period may correspond to a set of frames between an I-frame and the next I-frame.

The image encoding apparatus 100 may classify frames of an image for each IDR period, and may parallel process and encode the frames every IDR period. The image encoding apparatus 100 may parallel process and encode frames corresponding to the same level among frames in each IDR period. Also, the image encoding apparatus 100 may divide each of the frames into tiles, and may parallel process and encode the tiles. The image encoding apparatus 100 may encode the image by adaptively combining at least one of the tile-based parallel encoding scheme, the frame-based parallel encoding scheme, and the IDR period-based parallel encoding scheme, based on a performance of the image encoding apparatus 100, and thus it is possible to enhance an efficiency of encoding the image.

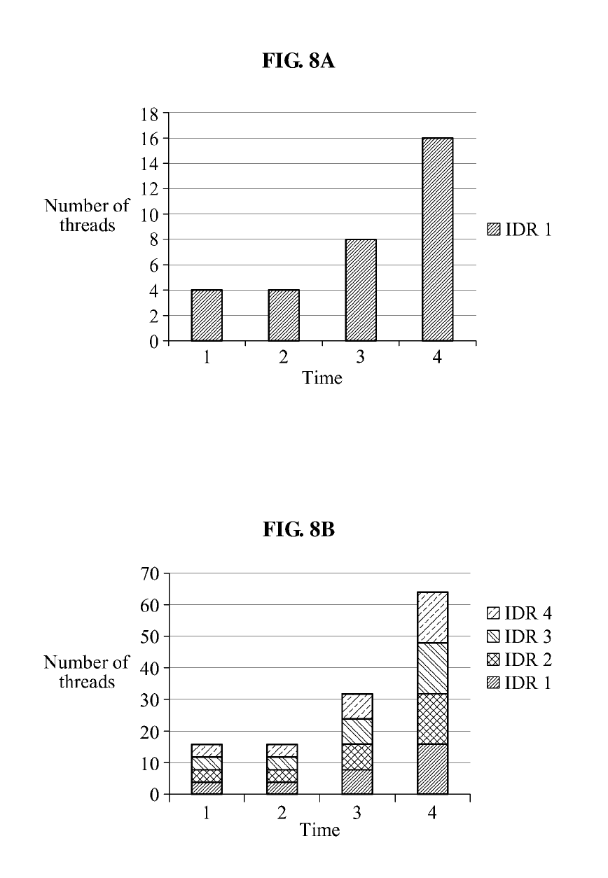

FIGS. 8A and 8B illustrate a number of threads occurring over time when parallel encoding is performed by combining various parallel encoding schemes according to an embodiment.

FIGS. 8A and 8B are graphs showing the number of threads occurring over time when the image encoding apparatus 100 of FIG. 1 encodes an image regardless of a performance of the image encoding apparatus 100. Referring to FIG. 8A, when the image is encoded regardless of the performance of the image encoding apparatus 100 by combining a tile-based parallel encoding scheme and a frame-based encoding parallel scheme for a single IDS period, the number of threads may increase over time. Referring to FIG. 8B, when IDR period-based parallel encoding schemes are additionally performed to encode the image, the number of threads may rapidly increase over time.

Embodiments may provide a method of solving imbalance of a number of threads occurring over time even though encoding is performed by adaptively combining at least one of a tile-based parallel encoding scheme, a frame-based parallel encoding scheme and an IDS period-based parallel encoding scheme. To solve the imbalance, a maximum frame division number may be verified based on a number of frames capable of being processed in parallel based on a GOP level and a number of processors acquired by the number-of-processors verifier 110 of FIG. 1.

For example, referring to FIG. 6, the image encoding apparatus 100 may verify four frames corresponding to GOP level 3. When the image encoding apparatus 100 encodes the four frames corresponding to the GOP level 3 using a parallel processing scheme, each of the four frames may be divided into N/4 tiles based on a maximum frame division number N determined based on the number of processors acquired by the number-of-processors verifier 110. Also, the image encoding apparatus 100 may verify two frames corresponding to GOP level 2. When the image encoding apparatus 100 encodes the two frames corresponding to the GOP level 2 using the parallel processing scheme, each of the two frames may be divided into N/2 tiles based on the maximum frame division number N.

As described above, the image encoding apparatus 100 may perform encoding by adaptively combining at least one of the tile-based parallel encoding scheme, the frame-based parallel encoding scheme and the IDS period-based parallel encoding scheme. Thus, it is possible to provide a parallel encoding method with a high efficiency in a given environment while maintaining a predetermined number of threads.

The units described herein may be implemented using hardware components, software components, or a combination thereof. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments have been shown and described, the present invention is not limited to the described embodiments. Instead, it would be appreciated by those skilled in the art that changes may be made to these exemplary embodiments without departing from the principles and spirit of the invention, the scope of which is defined by the claims and their equivalents.

What is claimed is:

1. An image encoding method comprising:
identifying a plurality of frames of an image; and
encoding the image by adaptively combining at least one of a tile-based parallel encoding scheme, a frame-based parallel encoding scheme, and an instantaneous decoding refresh (IDR) period-based parallel encoding scheme.

2. The image encoding method of claim 1, wherein the encoding of the image comprises dividing each of the plurality of frames into a plurality of tiles based on a number of available processors and encoding the plurality of tiles in parallel.

3. The image encoding method of claim 1, wherein the encoding of the image comprises processing frames corresponding to the same group of picture (GOP) level so that the frames corresponding to the same GOP level do not reference each other, and encoding the processed frames in parallel.

4. The image encoding method of claim 1, wherein the encoding of the image comprises encoding the plurality of frames in parallel every IDR period.

5. The image encoding method of claim 4, wherein the IDR period corresponds to frames between an I-frame and the next I-frame.

6. An image decoding method comprising:
receiving an image; and
decoding the received image,
wherein the image is encoded by encoding a plurality of frames of the image by combining at least one of a tile-based parallel encoding scheme, a frame-based parallel encoding scheme, and an instantaneous decoding refresh (IDR) period-based parallel encoding scheme.

7. The image decoding method of claim 6, wherein the decoding of the image comprises dividing each of the plurality of frames into a plurality of tiles based on a number of available processors, and decoding the plurality of tiles in parallel.

8. The image decoding method of claim 6, wherein the decoding of the image comprises processing frames corresponding to the same group of picture (GOP) level so that the frames corresponding to the same GOP level do not reference each other, and decoding the processed frames in parallel.

9. The image decoding method of claim 6, wherein the decoding of the image comprises decoding the plurality of frames in parallel every IDR period.

10. The image decoding method of claim 9, wherein the IDR period corresponds to frames between an I-frame and the next I-frame.

11. An image encoding apparatus comprising:
a frame identifier configured to identify a plurality of frames included in a group of picture (GOP);
a controller configured to process frames corresponding to the same GOP level among GOP levels of the identified frames so that the frames corresponding to the same GOP level do not reference each other;
a frame divider configured to divide each of the processed frames into a plurality of tiles, based on a number of available processors; and
an encoder configured to encode, in parallel, the processed frames for each of the GOP levels and for each of the plurality of tiles.
